(19) United States
(12) Patent Application Publication
(10) Pub. No.: US 2021/0080008 A1
(43) Pub. Date: Mar. 18, 2021

(54) Seal with Pressure Activatable Bead

(71) Applicant: Aktiebolaget SKF, Gothenburg (SE)

(72) Inventor: Robert D. Pecak, Naperville, IL (US)

(21) Appl. No.: 16/568,482

(22) Filed: Sep. 12, 2019

(51) Int. Cl. F16J 15/3244

(52) U.S. Cl. CPC F16J 15/3244

(57) ABSTRACT

A seal for sealing between an inner member and an outer member includes an annular seal body formed of an elastomeric material, disposed on one of the inner and outer members having an annular groove and has first and second circumferential surfaces. An annular actuator lug extends radially from the body second circumferential surface and is disposed within the annular groove. An annular sealing bead extends radially from the body first circumferential surface and circumferentially about or within the lug. An activation surface section of the first circumferential surface is defined adjacent to the sealing bead and extends circumferentially about or within a portion of the lug. The lug is configured to bias the sealing bead radially toward the circumferential surface of the other one of the inner and outer members when fluid pressure is exerted on the activation surface section.

### BACKGROUND OF THE INVENTION

The present invention relates to seals, and more particularly to annular elastomeric seals.

Annular elastomeric seals are known and include an annular body with a projecting lip or bead that seals against an annular surface of a shaft or bore. In certain applications, seals may be utilized on a piston assembly in which pressure must be sealed at multiple locations, such as within a region of direct pressure and another region with return pressure. It is generally difficult to fabricate a piston seal, particularly a bonded seal, for sealing at multiple locations without resorting to an assembly of multiple separate seals.

### SUMMARY OF THE INVENTION

In one aspect, the present invention is a seal for sealing an annular space between an inner member and an outer member, the inner member having an outer circumferential surface and the outer member having an inner circumferential surface. At least one of the inner and outer members is displaceable along a central axis and either the inner member has an annular groove extending inwardly from the outer circumferential surface or the outer member has an annular groove extending outwardly from the inner circumferential surface. The seal comprises an annular seal body formed of an elastomeric material and disposed on the one of the inner and outer members having the annular groove, the seal body having a first circumferential surface and an opposing second circumferential surface. An annular actuator lug extends radially from the second circumferential surface of the seal body and is disposed within the annular groove. Further, an annular sealing bead extends radially from the first circumferential surface of the seal body and extends circumferentially about the actuator lug or circumferentially within the actuator lug. The sealing bead has an axial length lesser than an axial length of the actuator lug such that an activation surface section of the seal body first circumferential surface is defined adjacent to the sealing bead and extends circumferentially about or within a portion of the actuator lug. Furthermore, the actuator lug is configured to bias the sealing bead radially toward the circumferential surface of the other one of the inner and outer members when fluid pressure is exerted on the activation surface section.

In a second aspect, the present invention is a mechanical assembly comprising an outer member having an inner circumferential surface and a central axis and an inner member disposed within the outer member and having an outer circumferential surface. The inner member is centered about the central axis such that an annular space is defined between the outer circumferential surface of the inner member and the inner circumferential surface of the outer member. At least one of the inner member and the outer member is linearly displaceable along the axis and either the outer member has an annular groove extending outwardly from the inner circumferential surface or the inner member has an annular groove extending inwardly from the outer circumferential surface. The mechanical assembly further comprises a seal for sealing the annular space as recited in the previous paragraph and further wherein a first portion of the actuator lug is defined axially between the first axial end of the actuator lug and the second axial end of the sealing bead so as to be generally radially adjacent to the sealing bead. A second portion of the actuator lug is defined axially between the second axial end the sealing bead and the outer axial end of the actuator lug so as to be generally radially adjacent to the activation surface section. The actuator lug is configured such that displacement of the second portion of the actuator lug into the groove biases the first portion of the actuator lug outwardly from the groove so as to bias the sealing bead radially outwardly from the first circumferential surface of the seal body.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a mechanical assembly including a seal in accordance with the present invention, depicting a first seal construction;

FIG. 2 is an enlarged broken-away view of a portion of FIG. 1;

FIG. 3 is an axial cross-sectional view of the first construction seal, shown mounted on an outer member;

FIG. 4 is an enlarged, broken away axial cross-sectional view of the first construction seal;

FIG. 5 is a more enlarged view of a portion of FIG. 4;

FIG. 6 is an axial cross-sectional view of a mechanical assembly including a seal in accordance with the present invention, depicting a second seal construction;

FIG. 7 is an enlarged, broken-away view of a portion of FIG. 6;

FIG. 8 is a more enlarged, broken-away axial cross-sectional view of a portion of the second construction seal;

FIG. 9 is a more enlarged, broken-away view of a portion of FIG. 6, showing a sealing bead in an un-activated state;

FIG. 10 is another view of the portion of FIG. 6 shown in FIG. 9, showing a sealing bead in an activated state;

FIG. 11 is a broken-away, axial cross-sectional view of an outer member of the mechanical assembly of FIG. 1, showing the outer member with an annular groove;

FIG. 12 is a broken-away, axial cross-sectional view of an inner member of the mechanical assembly of FIG. 6, showing the inner member with an annular groove;

FIG. 13 is a broken-away, axial cross-sectional view of the mechanical assembly of FIG. 6, showing a secondary O-ring seal; and

FIG. 14 is a broken-away, axial cross-sectional view of the mechanical assembly of FIG. 6, showing two activatable sealing beads.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. The terminology includes the words specifically mentioned above, derivatives thereof, and words of similar import.

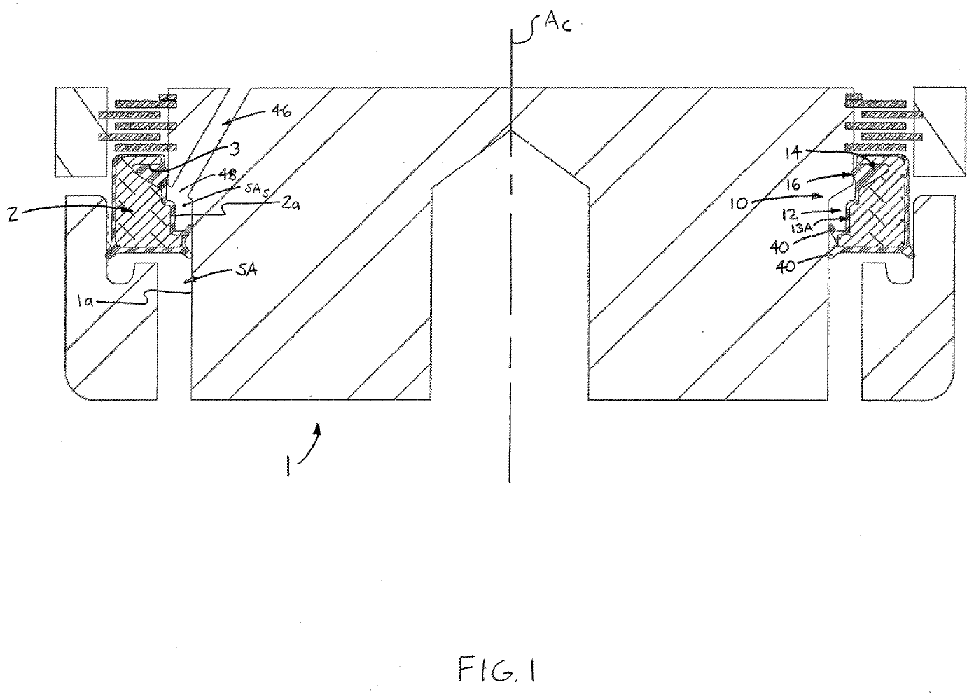

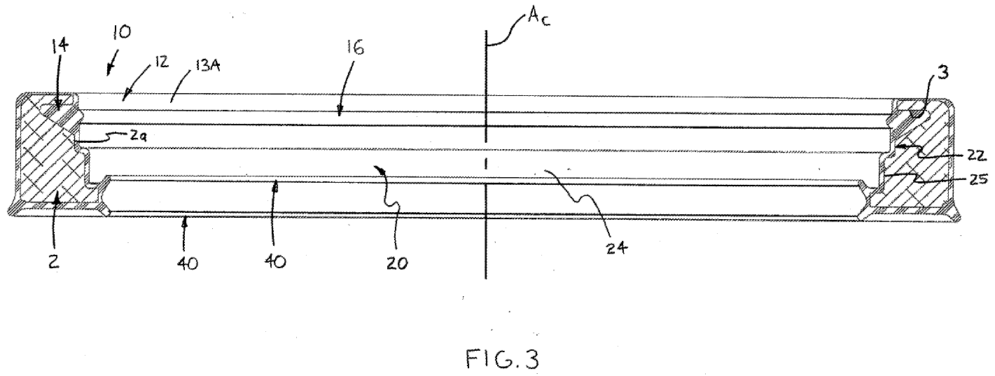

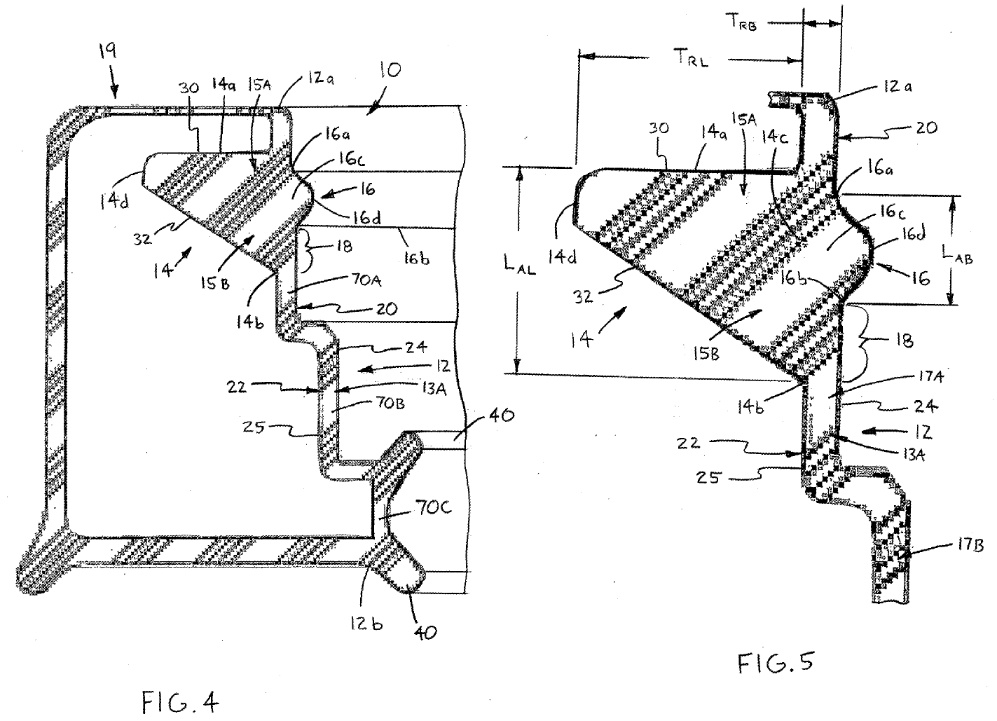

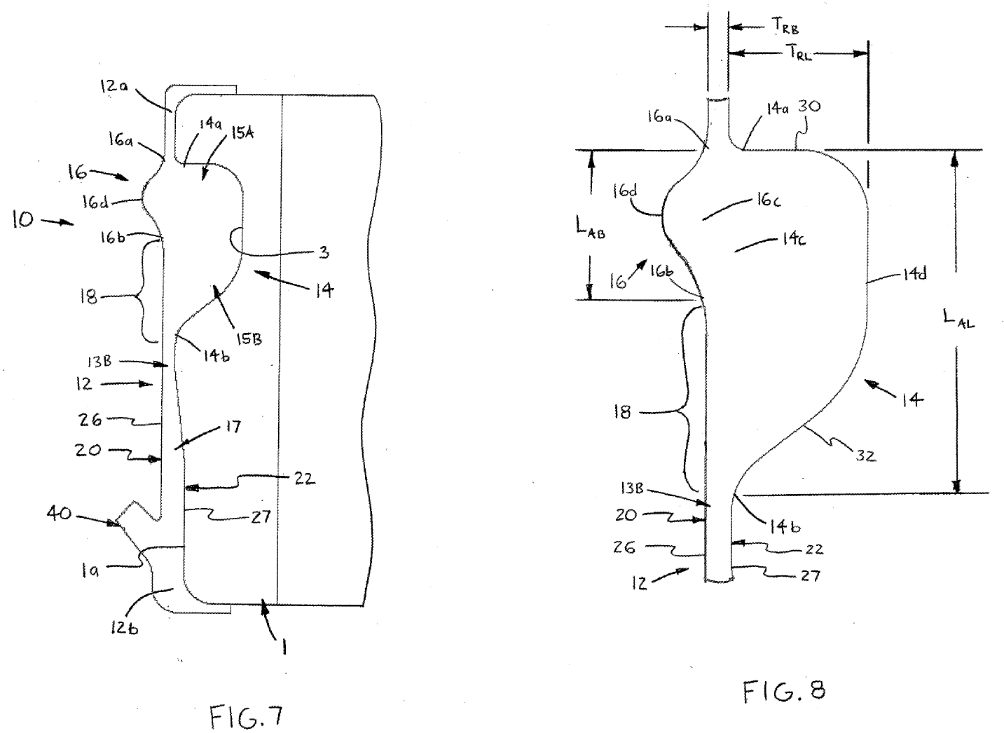

Referring now to the drawings in detail, wherein like numbers are used to indicate like elements throughout, there is shown in FIGS. 1-14 a seal 10 for sealing an annular space SA between an inner member 1 and an outer member 2. The inner and outer members 1, 2, respectively, may be for example, a piston and a cylinder, a shaft and a clutch actuator piston, a clutch actuator piston and a clutch balance piston, etc., with the inner member 1, the outer member 2 and the seal 10 being components of a mechanical assembly 4. The inner member 1 has an outer circumferential surface 1a and the outer member 2 is disposed coaxially about the inner member 1 and has an inner circumferential surface 2a spaced outwardly from the outer surface 1a so as to define the annular space SA. Either the inner member 1 or the outer member 2 is displaceable along a central axis A_{C} relative to the other member 2, 1, although in certain applications both members 1, 2 may be axially displaceable or/and angularly displaceable about the axis A_{C}. Further, one of the members 1, 2 is provided with an annular groove 3 extending circumferentially about the axis A_{C}; that is, depending on the application, the annular groove 3 is formed in the outer circumferential surface 1a of the inner member 1 or is formed in the inner circumferential surface 2a of the outer member 2. The seal 10 basically comprises an annular seal body 12, an annular actuator lug 14, an annular sealing bead 16 and an activation surface section 18, the lug 14 being configured to bias the bead 16 radially when pressure is exerted on the surface section 18 to increase sealing pressure or load, as described in detail below.

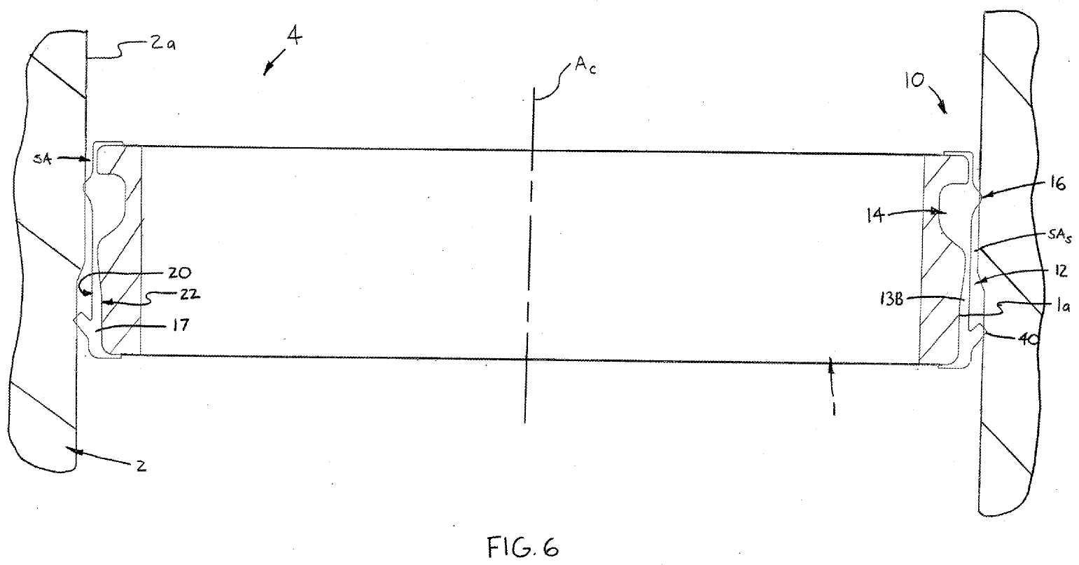

Specifically, the seal body 12 is formed of an elastomeric material, such as natural or synthetic rubber, and is disposed on the one of the inner and outer members 1, 2 having the groove 3. The seal body 12 is generally tubular and has opposing axial ends 12a, 12b, a first circumferential surface 20 and an opposing second circumferential surface 22, a radial thickness T_{RB} being defined between the two circumferential surfaces 20, 22. Each circumferential surface 20, 22 may be formed as a single, axially continuous surface, as shown in FIGS. 6-8, or may be formed of separate, axially spaced sections of different diameters, as depicted in FIGS. 1-4. More specifically, the seal body 12 may be formed as a single tubular body section 17 with generally constant inside and outside diameters (FIGS. 6-8) or as two or more axially spaced tubular body sections 17A, 17B, 17C, etc., each having inside and outside diameters different from the other body sections 17A, 17B, 17C (FIGS. 1-4). Also, in either case, the seal body 12 may be a separate annular body, as depicted in FIGS. 6-8, or may be part of an overmolded body 19 as shown in FIGS. 1-4.

Further, the actuator lug 14 provides a mass of generally incompressible material for reasons described below, extends radially from the second circumferential surface 22 of the seal body 12 and is disposed within the annular groove 3 when the seal 10 is installed on either the inner member 1 or the outer member 2. The lug 14 has opposing first and second axial ends 14a, 14b, a first radial end 14c integrally formed with the seal body 12 and an opposing, free second radial end 14d. The lug 14 is preferably formed having generally triangular axial cross-sections (FIGS. 1-5) or generally trapezoidal cross-sections (FIGS. 6-10, 13 and 14) so as to complement the structure of the groove 3, as discussed below, but may have any other appropriate shape (i.e., generally rectangular, generally semi-circular, etc.). Also, the actuator lug 14 has a radial thickness T_{RL} (FIGS. 5 and 8) defined between the first radial end 14c and the second radial end 14d. The radial thickness T_{RL} of the actuator lug 14 is substantially greater than the radial thickness T_{RB} of the seal body 12 in order to provide a sufficient material mass for the lug 14 to function as described below. Specifically, a ratio of radial thickness T_{RL} of the actuator lug 14 to the radial thickness T_{RB} of the seal body 12 is at least 2.0, i.e., T_{RL}/T_{RB}>2.0, and may be greater than 4.0.

Furthermore, the sealing bead 16 extends radially from the first circumferential surface 20 of the seal body 12 and extends circumferentially about the actuator lug 14 (FIGS. 6-10) or circumferentially within the actuator lug 14 (FIGS. 1-5). The sealing bead 16 has opposing first and second axial ends 16a, 16b, respectively, a first radial end 16c integrally formed with the seal body 12 and an opposing, second “free” radial end 16d. The bead 16 is located on the seal body 12 such that the first axial end 16a of the bead 16 is generally axially aligned with the first axial end 14a of the actuator lug 14. Preferably, the bead 16 has generally semi-circular axial cross-sections and is formed as a circular projection that extends substantially continuously about the central axis A_{C}, as depicted, but may alternatively be formed as a plurality of discrete arcuate projections (not shown) of any appropriate cross-sectional shape.

Also, the sealing bead 16 has an axial length LAB that is lesser than an axial length LAL of the actuator lug 14, as indicated in FIGS. 5 and 8. As such, the activation surface section 18 of the seal body first circumferential surface 20 is defined adjacent to the sealing bead 16 and extends circumferentially about (FIGS. 6-10) or within (FIGS. 1-5) a portion of the actuator lug 14. The activation surface section 18 extends axially between the second axial end 16b of the sealing bead 16 and the second axial end 14b of the actuator lug 14.

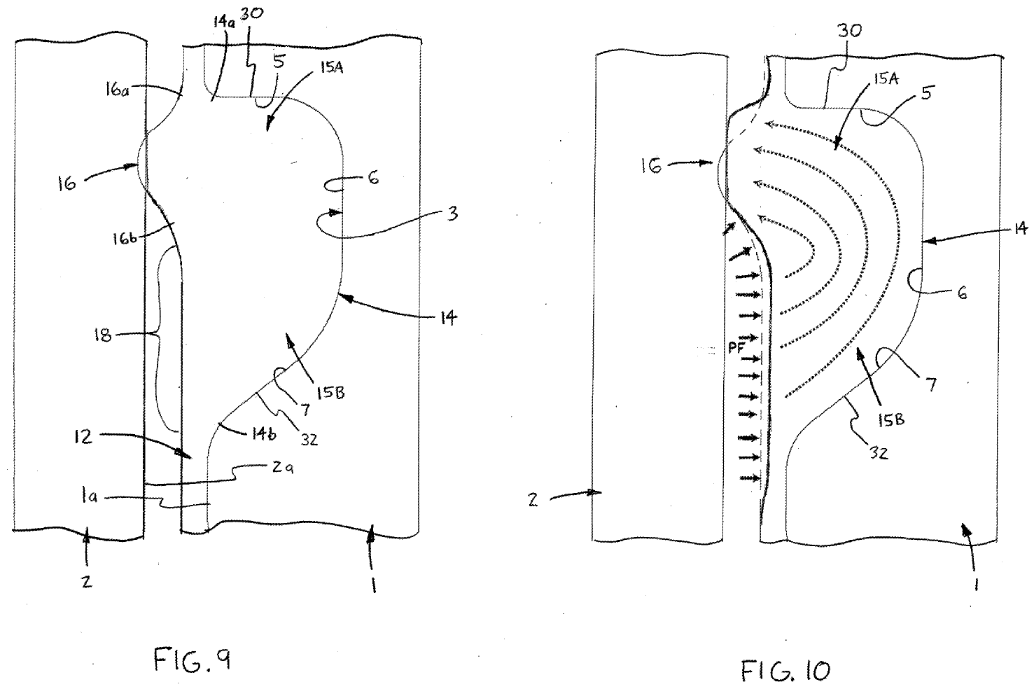

Referring to FIGS. 5, 8, 9 and 10, the actuator lug 14 is configured to bias the sealing bead 16 radially toward the circumferential surface 2a or 1a of the other one of the outer and inner members 2, 1 (i.e., the member 1 or 2 not providing the groove 3) when fluid pressure PF (see FIG. 10) is exerted on the activation surface section 18, thereby increasing the sealing pressure of the bead 16 against the surface 2a or 1a, the sealing pressure of the bead 16 increasing with increasing pressure PF on the surface 18, and vice-versa. More specifically, a first portion 15A of the actuator lug 14 is defined axially between the first axial end 14a of the actuator lug 14 and the second axial end 16b of the sealing bead 16; in other words, the actuator lug first portion 15A is generally bounded axially by the sealing bead 16. Also, a second portion 15B of the actuator lug 14 is defined axially between the second axial end 16b of the sealing bead 16 and the second axial end 14c of the actuator lug 14, that is, the actuator lug second portion 15B is generally bounded axially by the activation surface section 18.

As best shown in FIG. 10, the actuator lug 14 is configured such that fluid pressure PF exerted on the second portion 15B of the actuator lug 14 (i.e., on the activation surface 18) forces the lug second portion 15B into the groove 3 and against the lug first portion 15A, thereby causing the lug first portion 15A to displace or expand outwardly from the groove 3 and bias/displace the sealing bead 16 radially away from the seal body first circumferential surface 20. The biasing of the sealing bead 16 functions to increase the sealing pressure of the bead 16 against the surface 1a or 2a of the other member 1, 2 respectively, i.e., other than the member 1 or 2 on which the seal 10 is mounted. As such, the mechanical assembly 4 is capable of operating under relatively lower friction conditions when the bead 16 is in an un-activated state (e.g., FIG. 9) until greater sealing pressure is required, at which point the lug 14 biases the bead 16 into an activated state (FIG. 10).

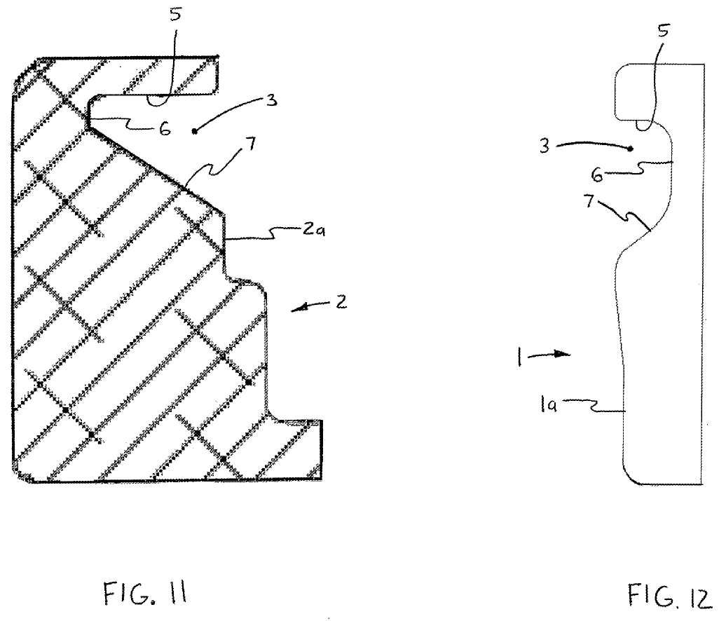

Referring to FIGS. 5, 8, 11 and 12, the “pressure activated” biasing of the sealing bead 16 by the actuator lug 14 is facilitated by the complementary structures of the lug 14 and the groove 3, as follows. Preferably, the actuator lug 14 has a radially-extending surface 30 on the first axial end 14a and an angled surface 32 (i.e., surface 32 extends both axially and radially) on the second axial end 14c. The angled surface 32 is oriented such that the second radial end 14d has an axial length that is substantially lesser than the axial length of the first radial end 14c, and thus provides the generally triangular or trapezoidal axial cross-sectional shape of the lug 14. As indicated in FIGS. 11 and 12, the member groove 3 is preferably defined by a radial surface 5, which extends outwardly from the inner surface 2a of the outer member 2 or inwardly from the outer surface 1a of the inner member 1, a generally circumferential surface 6 extending axially from the radial surface 5, and an angled surface 7 extending radially and axially between the inner circumferential surface 2a of the outer member 2, or the outer circumferential surface 1a of the inner member 1, and the circumferential surface 6. However, the groove 3 may have any other appropriate cross-sectional shape, which preferably complements or corresponds to the particular shape of the lug 14, but may also have a shape that is different than or non-complementary with the lug 14.

With the preferred complementary groove and lug structure, the first portion 15A of the actuator lug 14 is disposed against the radial surface 5 of the groove 3 and the second portion 15B of the actuator lug 14 is disposed against the angled surface 7 of the groove 3. As such, fluid pressure on the activation surface section 18 pushes the lug second portion 15B against the groove angled surface 7, causing the lug second portion 15B to become biased or displaced radially inwardly (i.e., into the groove 3) and axially toward the lug first portion 15A. Such biasing/movement of the lug second portion 15B pushes the lug first portion 15A against the groove radial surface 5 and causes the first portion 15A to become biased or pushed along the radial surface 5 in a radial direction outwardly from the groove 3, thereby radially biasing the sealing bead 16 against the outer surface 1a or the inner surface 2a. Having described the basic structure and functioning above, these and other elements of the seal 10 of the present invention are described in greater detail below.

In a first preferred construction depicted in FIGS. 1-5, the seal body 12 is a first seal body 13A configured to be disposeable upon the inner surface 2a of the outer member 2, such that the first circumferential surface 20 is an inner circumferential surface 24 and the second circumferential surface 22 is an outer circumferential surface 25. In such a construction, the actuator lug 14 extends radially outwardly from the outer circumferential surface 25 and is disposed within an annular groove 3 formed in the outer member 2, and the sealing bead 16 extends radially inwardly from the inner circumferential surface 24, is circumferentially disposed within the lug 14 and is sealingly engageable with the outer circumferential surface 1a of the inner member 1.

In a second preferred construction depicted in FIGS. 6-10, 13 and 14, the seal body 12 is a second seal body 13B configured to be disposeable upon the outer surface 1a of the inner member 1, such that the first circumferential surface 20 is an outer circumferential surface 26 and the second circumferential surface 22 is an inner circumferential surface 27. In the second construction, the actuator lug 14 extends radially inwardly from the inner circumferential surface 27 and is disposed within an annular groove 3 formed in the inner member 1. Further, the sealing bead 16 extends radially outwardly from the outer circumferential surface 26, is circumferentially disposed about the lug 14 and is sealingly engageable with the inner circumferential surface 2a of the outer member 2.

With either construction, the seal 10 may further comprise one or more (e.g., two, three, etc.) annular sealing lips 40 each extending at least partially radially from the first circumferential surface 20 of the seal body 12, that is, radially inwardly from the inner circumferential surface 24 of the first seal body 13A or radially outwardly from the outer circumferential surface 26 of the second seal body 13B. Each sealing lip 40 is spaced axially from the sealing bead 16 and is sealingly engageable with the outer circumferential surface 1a of the inner member 1 or the inner circumferential surface 2a of the outer member 2. Also, each sealing lip 40 is preferably formed as a generally frustoconical tube having a first end integrally formed with the first surface 20 of the seal body 12 and an opposing, second, free end sealingly engageable with the outer surface 1a of the inner member 1 or the inner surface 2a of the outer member 2. Although preferably frustoconical in shape so as to extend both axially and radially, each sealing lip 40 may have any other appropriate shape.

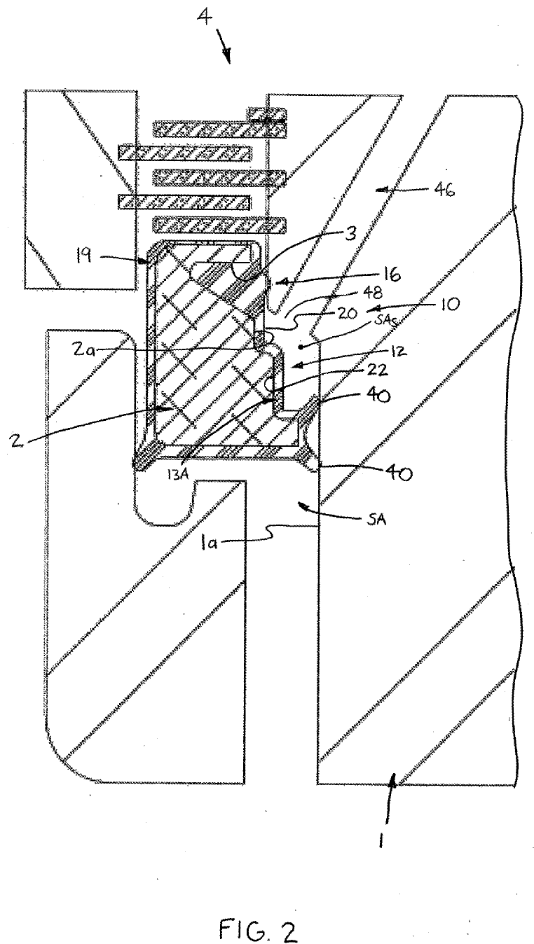

Preferably, the sealing bead 16 and the sealing lip 40 most proximal to the bead 16 are configured to retain a quantity of fluid in a section SA_{S} of the annular space activates biasing of the sealing bead 16, as described above. However, the mechanical assembly 4 may be provided with means to pressurize the annular space section SA_{S}, such as for example, a fluid passage 46 with a port 48 located between the bead 16 and the most proximal lip 40, which directs pressurized fluid into the annular space section SA_{S}, which activates the sealing bead 16, as shown in FIGS. 1 and 2.

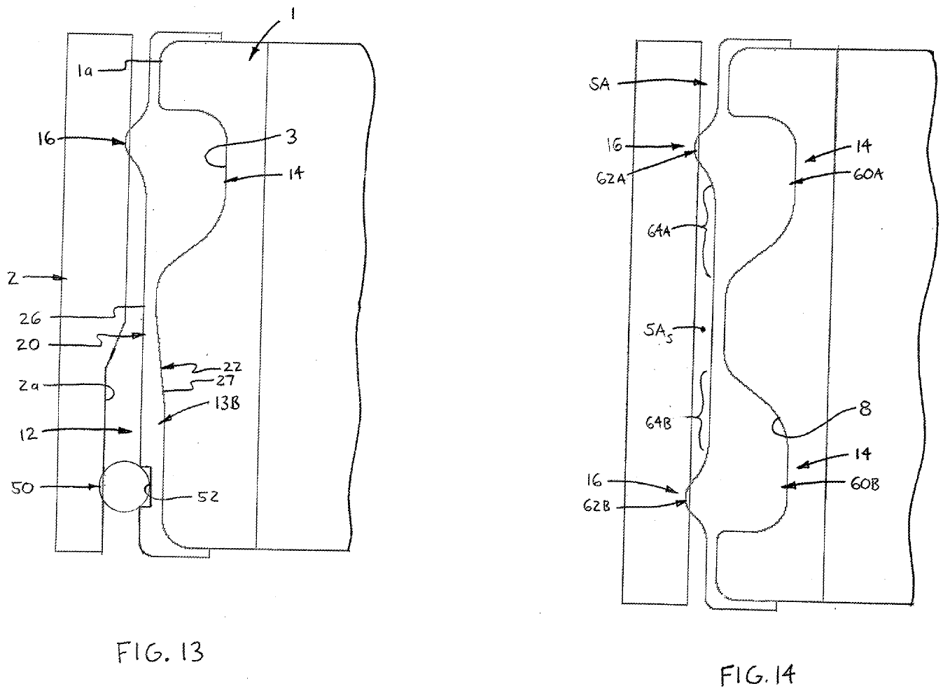

Referring to FIG. 13, in place of or in combination with the sealing lip(s) 40, the seal 10 may further comprise one or more O-rings 50 coupled with the seal body 12, e.g., partially disposed within an annular groove 52 of the body 12. Each O-ring 50 extends radially inwardly from the inner circumferential surface 24 of the first seal body 13A (not shown) or radially outwardly from the outer circumferential surface 26 of the second body 13B (as depicted) and is spaced axially from the sealing bead 16. Further, the O-ring(s) 50 are each sealingly engageable with the inner circumferential surface 2a of the outer member 2, as depicted, or the outer circumferential surface 1a of the inner member 1 (structure not shown).

Referring to FIG. 14, the seal 10 may alternatively be formed without any seal lips or O-rings, and instead have only the sealing bead 16 to seal the axial space SA (structure not depicted). As a further alternative, the seal 10 may be formed with two actuator lugs 14 and two sealing beads 16. Specifically, a first actuator lug 60A is formed as described above with the lug 14 and a second actuator lug 60B extends radially outwardly from the same circumferential surface 20 or 22 of the seal body 12, is disposed within another annular groove 8 of the same member 1 or 2 and is spaced axially from the first actuator lug 60A. A first sealing bead 62A and a first activation surface section 64A are each formed as described above with the sealing bead 16 and the activation surface section 18. Also, a second sealing bead 62B extends radially inwardly from the same circumferential surface 20 or 22 of the seal body 12 as the first bead 62A, extends circumferentially within or about the second actuator lug 60B, and is spaced axially from the first sealing bead 62A.

Further, the second sealing bead 62B has an axial length (not indicated) lesser than an axial length (not indicated) of the second actuator lug 60B, such that a second activation surface section 64B of the seal body circumferential surface 20 or 22 is defined adjacent to the second sealing bead 62B. The second activation surface section 64B extends circumferentially within or about a portion of the second actuator lug 60B and the second sealing bead 62B is preferably positioned axially relative to the second actuator lug 60B such that both activation surface sections 64A, 64B are disposed axially between the two sealing beads 62A, 62B. Furthermore, the second actuator lug 60B is configured to bias the second sealing bead 62B radially when fluid pressure is exerted on the second activation surface section 64B. With the preferred orientation of the two activation surface sections 64A, 64B, a quantity of pressurized fluid contained in the annular space SA_{S} between the two sealing beads 62A, 62B activates the two beads 62A, 62B.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

I claim:

1. A seal for sealing an annular space between an inner member and an outer member, the inner member having an outer circumferential surface and an outer member having an inner circumferential surface, one of the inner and outer members being displaceable along a central axis and the inner member has an annular groove extending inwardly from the outer circumferential surface or the outer member has an annular groove extending outwardly from the inner circumferential surface, the seal comprising:
an annular seal body formed of an elastomeric material and disposed on the one of the inner and outer members having the annular groove, the seal body having a first circumferential surface and an opposing second circumferential surface;
an annular actuator lug extending radially from the second circumferential surface of the seal body and disposed within the annular groove; and
an annular sealing bead extending radially from the first circumferential surface of the seal body and extending circumferentially about the actuator lug or circumferentially within the actuator lug, the sealing bead having an axial length lesser than an axial length of the actuator lug such that an activation surface section of the seal body first circumferential surface is defined adjacent to the sealing bead and extending circumferentially about or within a portion of the actuator lug, the actuator lug being configured to bias the sealing bead radially toward the circumferential surface of the other one of the inner and outer members when fluid pressure is exerted on the activation surface section.

2. A seal for sealing an annular space between an inner member and an outer member, the inner member having an outer circumferential surface and an outer member having an inner circumferential surface, one of the inner member and the outer member being displaceable along a central axis, the outer member having an annular groove extending radially outwardly from the inner circumferential surface, the seal comprising:
an annular seal body formed of an elastomeric material and disposed upon the inner circumferential surface of the outer member, the body having an inner circumferential surface and an outer circumferential surface;
an annular actuator lug extending radially outwardly from the outer circumferential surface of the seal body and disposed within the outer member annular groove; and
an annular sealing bead extending radially inwardly from the inner circumferential surface of the seal body and extending circumferentially within the actuator lug, the sealing bead having an axial length lesser than an axial length of the actuator lug such that an activation surface section of the seal body inner circumferential surface is defined adjacent to the sealing bead and extends circumferentially within a portion of the actuator lug, the actuator lug being configured to bias the sealing bead radially inwardly toward the outer circumferential surface of the inner member when fluid pressure is exerted on the activation surface section.

3. The seal as recited in claim 2 wherein the seal further comprises one of:
at least one annular sealing lip extending at least partially radially inwardly from the inner circumferential surface of the seal body, spaced axially from the sealing bead and being sealingly engageable with the outer circumferential surface of the inner member; and
an O-ring coupled with the seal body so as to extend radially inwardly from the seal body inner circumferential surface, spaced axially from the sealing bead and being sealingly engageable with the outer circumferential surface of the inner member.

4. The seal as recited in claim 2 wherein the actuator lug is a first actuator lug, the sealing bead is a first sealing bead, the activation surface is a first activation surface and the seal further comprises:
a second annular actuator lug extending radially outwardly from the outer circumferential surface of the seal body, disposed within another annular groove of the outer member and spaced axially from the first actuator lug; and
a second annular sealing bead extending radially inwardly from the inner circumferential surface of the seal body, extending circumferentially within the second actuator lug, and spaced axially from the first sealing bead, the second sealing bead having an axial length lesser than an axial length of the second actuator lug such that a second activation surface section of the seal body inner circumferential surface is defined adjacent to the second sealing bead and extends circumferentially within a portion of the second actuator lug, the second actuator lug being configured to bias the second sealing bead radially inwardly toward the outer circumferential surface of the inner member when fluid pressure of a predetermined magnitude is exerted on the second activation surface section.

5. The seal as recited in claim 2 wherein:
the actuator lug has a first axial and a second axial end, the sealing bead has a first axial end and a second axial end, and the first axial end of the sealing is being generally axially aligned with the first axial end of the actuator lug; and
a first portion of the actuator lug is defined axially between the first axial end of the actuator lug and the second axial end of the sealing bead and a second portion of the actuator lug is defined axially between the second axial end of the sealing bead and the second axial end of the actuator lug, the actuator lug being configured such that displacement of the second portion of the actuator lug into the groove biases the first portion of the actuator lug outwardly from the groove so as to displace the sealing bead radially inwardly from the inner circumferential surface of the seal body.

6. The seal as defined in claim 2 wherein:
the actuator lug has a first axial and a second axial end, the sealing bead has a first axial end and a second axial end, and the first axial end of the sealing bead is generally axially aligned with the first axial end of the actuator lug; and
the activation surface section extends axially between the second axial end of the sealing bead and the second axial end of the actuator lug.

7. The seal as recited in claim 2 wherein:
the seal body has a radial thickness defined between the inner circumferential surface and the outer circumferential surface; and
the actuator lug has an outer radial end integrally formed with the outer circumferential surface of the seal body, an opposing inner radial end and a radial thickness defined between the outer radial end and the inner radial end, the radial thickness of the actuator lug being substantially greater than the radial thickness of the seal body.

8. The seal as recited in claim 7 wherein a ratio of radial thickness of the actuator lug to the radial thickness of the seal body is at least 2.0.

9. A seal for sealing an annular space between an inner member and an outer member, the inner member having an outer circumferential surface and an outer member having an inner circumferential surface, one of the inner member and the outer member being displaceable along a central axis, the inner member having an annular groove extending radially inwardly from the outer circumferential surface, the seal comprising:
an annular seal body formed of an elastomeric material and disposed upon the outer circumferential surface of the inner member, the body having an inner circumferential surface and an outer circumferential surface;
an annular actuator lug extending radially inwardly from the inner circumferential surface of the seal body and disposed within the inner member annular groove; and
an annular sealing bead extending radially outwardly from the outer circumferential surface of the seal body and extending circumferentially about the actuator lug, the sealing bead having an axial length lesser than an axial length of the actuator lug such that an activation surface section of the seal body outer circumferential surface is defined adjacent to the sealing bead and extends circumferentially about a portion of the actuator lug, the actuator lug being configured to bias the sealing bead radially outwardly toward the inner circumferential surface of the outer member when fluid pressure is exerted on the activation surface section.

10. The seal as recited in claim 9 wherein the seal further comprises at least one of:
at least one annular sealing lip extending radially outwardly from the outer circumferential surface of the seal body, spaced axially from the sealing bead and configured to sealingly engage with the inner circumferential surface of the outer member; and
an O-ring coupled with the seal body so as to extend radially outwardly from the seal body outer circumferential surface, spaced axially from the sealing bead and being sealingly engageable with the inner circumferential surface of the outer member.

11. The seal as recited in claim 9 wherein the actuator lug is a first actuator lug, the sealing bead is a first sealing bead, the activation surface is a first activation surface and the seal further comprises:
a second annular actuator lug extending radially inwardly from the inner circumferential surface of the seal body, disposed within another annular groove of the inner member and spaced axially from the first actuator lug; and
a second annular sealing bead extending radially outwardly from the outer circumferential surface of the seal body, extending circumferentially about the actuator lug, and spaced axially from the sealing bead, the second sealing bead having an axial length lesser than an axial length of the second actuator lug such that a second activation surface section of the seal body outer circumferential surface is defined adjacent to the second sealing bead and extends circumferentially about a portion of the second actuator lug, the second actuator lug being configured to bias the second sealing bead radially outwardly toward the inner circumferential surface of the outer member when fluid pressure of a predetermined magnitude is exerted on the second activation surface section.

12. The seal as recited in claim 9 wherein:
the actuator lug has a first axial end and a second axial end, the sealing bead has a first axial end and a second axial end, and the first axial end of the sealing bead is generally axially aligned with the first axial end of the actuator lug; and
a first portion of the actuator lug is defined axially between the first axial end of the actuator lug and the second axial end of the sealing bead so as to be generally radially adjacent to the sealing bead and a second portion of the actuator lug is defined axially between the second axial end of the sealing bead and the second axial end of the actuator lug so as to be generally radially adjacent to the activation surface section, the actuator lug being configured such that displacement of the second portion of the actuator lug into the groove biases the first portion of the actuator lug outwardly from the groove so as to displace the sealing bead radially outwardly from the outer circumferential surface of the seal body.

13. The seal as defined in claim 9 wherein:
the actuator lug has a first axial end and a second axial end, the sealing bead has a first axial end and a second axial end, and the first axial end of the sealing bead is generally axially aligned with the first axial end of the actuator lug; and
the activation surface section extends axially between the second axial end of the sealing bead and the second axial end of the actuator lug.

14. The seal as recited in claim 9 wherein:
the seal body has a radial thickness defined between the inner circumferential surface and the outer circumferential surface; and
the actuator lug has an outer radial end integrally formed with the inner circumferential surface of the seal body, an opposing inner radial end and a radial thickness defined between the outer radial end and the inner radial end, the radial thickness of the actuator lug being substantially greater than the radial thickness of the seal body.

15. The seal as recited in claim 14 wherein a ratio of radial thickness of the actuator lug to the radial thickness of the seal body is at least 2.0.

16. A mechanical assembly comprising:
an outer member having an inner circumferential surface and a central axis;
an inner member disposed within the outer member and having an outer circumferential surface, the inner member being centered about the central axis such that an annular space is defined between the outer circumferential surface of the inner member and the inner circumferential surface of the outer member, one of the inner member and the outer member being linearly displaceable along the axis and the outer member has an annular groove extending outwardly from the inner circumferential surface or the inner member has an annular groove extending inwardly from the outer circumferential surface; and
a seal for sealing the annular space including:
an annular seal body formed of an elastomeric material and disposed on the one of the inner and outer members having the groove, the seal body having a first circumferential surface and an opposing second circumferential surface;
an annular actuator lug extending radially from the second circumferential surface of the seal body and disposed within the annular groove, the actuator lug having a first axial end, a second axial end and an axial length defined between the first and second axial ends; and
an annular sealing bead extending radially from the first circumferential surface of the seal body and extending circumferentially about the actuator lug or circumferentially within the actuator lug, the sealing bead having a first axial end, a second axial end and an axial length defined between the first and second axial ends, the axial length of the sealing bead being lesser than an axial length of the actuator lug such that an activation surface section of the seal body first circumferential surface is defined adjacent to the sealing bead and extending circumferentially about or within a portion of the actuator lug, the actuator lug being configured to bias the sealing bead radially toward the circumferential surface of the other one of the inner and outer members when fluid pressure is exerted on the activation surface section;
wherein a first portion of the actuator lug is defined axially between the first axial end of the actuator lug and the second axial end of the sealing bead so as to be generally radially adjacent to the sealing bead and a second portion of the actuator lug is defined axially between the second axial end the sealing bead and the outer axial end of the actuator lug so as to be generally radially adjacent to the activation surface section, the actuator lug being configured such that displacement of the second portion of the actuator lug into the groove biases the first portion of the actuator lug outwardly from the groove so as to displace the sealing bead radially outwardly from the first circumferential surface of the seal body.

17. The mechanical assembly as recited in claim 16 wherein:
the annular groove is defined by a generally radial surface section extending radially outwardly from the inner circumferential surface of the outer member, a generally circumferential surface section extending axially from the radial surface section and an angled surface section extending radially and axially between the outer circumferential surface and the circumferential surface section; or
the annular groove is defined by a generally radial surface section extending radially inwardly from the outer circumferential surface of the inner member, a generally circumferential surface section extending axially from the radial surface section and an angled surface section extending radially and axially between the outer circumferential surface and the circumferential surface section; and
wherein the first portion of the actuator lug is disposed against the radial surface of the groove and a second portion of the of the actuator lug is disposed against the angled surface of the groove such that pressure on the activation surface section biases the second portion of the actuator lug radially and axially toward the first portion of the lug so that the first portion of the actuator lug is biased radially along the radial surface section and outwardly from the groove.

18. The mechanical assembly as recited in claim 17 wherein the seal further comprises at least one of:
at least one annular sealing lip extending radially from the first circumferential surface of the seal body, spaced axially from the sealing bead and configured to sealingly engage with the circumferential surface of the other one of the inner and outer members; and
an O-ring coupled with the seal body so as to extend radially from the seal body first circumferential surface, spaced axially from the sealing bead and being sealingly engageable with the circumferential surface of the other one of the inner and outer members.
